(19) United States
(12) Patent Application Publication
(10) Pub. No.: US 2026/0100752 A1
(43) Pub. Date: Apr. 9, 2026

(54) ITERATIVE MINIMUM MEAN SQUARE ERROR (MMSE) DETECTION METHODS FOR MULTIPLE-INPUT MULTIPLE-OUTPUT (MIMO) COMMUNICATION SYSTEMS

(71) Applicant: Samsung Electronics Co., Ltd., Gyeonggi-do (KR)

(72) Inventors: Jaber Mohammad BORRAN, Carlsbad, CA (US); Jung Hyun BAE, San Diego, CA (US)

(21) Appl. No.: 19/353,112

(22) Filed: Oct. 8, 2025

Related U.S. Application Data
(60) Provisional application No. 63/704,908, filed on Oct. 8, 2024.
(60) Provisional application No. 63/795,772, filed on Apr. 28, 2025.

(51) Int. Cl. H04B 7/08; H04B 7/0413; H04L 25/03

(52) U.S. Cl. CPC H04B 7/0854; H04B 7/0413; H04L 25/03318

(57) ABSTRACT

A method of detecting signals in a multiple-input multiple-output (MIMO) communication system is provided. The method includes: receiving a signal vector and a channel matrix associated with transmissions from a plurality of antennas; initializing symbol information for the signal vector; applying a minimum mean square error (MMSE) detection process to the signal vector to generate updated symbol information; repeating the MMSE detection process for a plurality of iterations, each iteration including further updating the symbol information based on outputs of a previous iteration, wherein the MMSE detection process is performed using a real-valued system model of the signal vector; and outputting final symbol information from the MMSE detection process as detected symbols.

### CROSS-REFERENCE TO RELATED APPLICATIONS

This application claims the priority benefit under 35 U.S.C. § 119 (e) of U.S. Provisional Application No. 63/704,908, filed on Oct. 8, 2024, and 63/795,772, filed on Apr. 28, 2025, the disclosures of which are incorporated by reference in their entireties as if fully set forth herein.

### TECHNICAL FIELD

The disclosure generally relates to signal detection in multiple-input multiple-output (MIMO) communication systems. More particularly, the subject matter disclosed herein relates to improvements to iterative minimum mean square error (MMSE) detection algorithms.

### SUMMARY

Wireless communication systems may employ MIMO technology to improve throughput and reliability by transmitting and receiving multiple data streams across multiple antennas. Accurate detection of transmitted symbols in such systems is desired to achieve high data rates, particularly for higher-order modulation schemes.

To accurately detect transmitted symbols, iterative detection algorithms, such as linear MMSE detectors and approximate message passing (AMP)-based schemes, have been employed. These approaches may refine symbol estimates over multiple iterations using soft information to reduce detection error.

One issue with the above types of approaches is that iterative MMSE detection may be performed in a complex domain, which assumes circularly symmetric signal and noise distributions. This assumption breaks down after the first iteration, leading to inaccuracies in variance tracking and posterior symbol updates. In addition, algorithms that rely solely on soft estimates can incur high computational complexity, while hard-decision methods may suffer from error propagation.

To overcome these types of issues, systems and methods are described herein for iterative MMSE detection using a real-valued system model, which preserves accuracy across multiple iterations, and for integrating maximum likelihood approximation (MLA) with hard-decision and soft-decision feedback into the iterative process. Certain embodiments further reduce complexity by limiting MLA candidates to a subset of symbol positions or to a predetermined number of candidates.

The above approaches improve on previous methods because they maintain detection accuracy across iterations, reduce computational burden through selective candidate expansion and pruning, and provide flexible trade-offs between accuracy and complexity using hard-decision and soft-decision feedback mechanisms.

In an embodiment, a method of detecting signals in a MIMO communication system comprises: receiving a signal vector and a channel matrix associated with transmissions from a plurality of antennas; initializing symbol information for the signal vector; applying an MMSE detection process to the signal vector to generate updated symbol information; repeating the MMSE detection process for a plurality of iterations, each iteration including further updating the symbol information based on outputs of a previous iteration, wherein the MMSE detection process is performed using a real-valued system model of the signal vector; and outputting final symbol information from the MMSE detection process as detected symbols.

In an embodiment, a method of detecting signals in a MIMO communication system comprises: receiving a signal vector and a channel matrix associated with transmissions from a plurality of antennas, each element of the signal vector corresponding to a receive antenna; initializing symbol information for the signal vector; applying an MMSE detection process to the signal vector; generating one or more candidate symbol vectors for one or more transmit layers using an MLA, wherein each candidate symbol vector is expanded using the MMSE detection process applied to remaining transmit layers; selecting hard-decision symbol estimates from among the evaluated candidate symbol vectors; and outputting final hard-decision symbol estimates from the MMSE detection process as detected symbols.

In an embodiment, a method of detecting signals in a MIMO communication system comprises: receiving a signal vector and a channel matrix associated with transmissions from a plurality of antennas, each element of the signal vector corresponding to a receive antenna; initializing symbol information for the signal vector; applying an MMSE detection process to the signal vector; generating one or more candidate symbol vectors for one or more transmit layers using an MLA, wherein each candidate symbol vector is expanded using the MMSE detection process applied to remaining transmit layers; computing soft-decision probabilities for symbols of the signal vector based on the evaluated candidate symbol vectors; and outputting final symbol estimates from the soft-decision probabilities as detected symbols.

### BRIEF DESCRIPTION OF THE DRAWINGS

In the following section, the aspects of the subject matter disclosed herein will be described with reference to exemplary embodiments illustrated in the figures, in which:

FIG. 1 is a flowchart illustrating signal detection according to an iterative MMSE (IMMSE-Real) method, in which per-dimension variance scaling and a real-valued system model are applied during successive iterations, according to an embodiment;

FIG. 2 is a flowchart illustrating signal detection according to an iterative MMSE method with maximum likelihood approximation and hard-decision updates (IMMSE-MLA-HD), according to an embodiment;

FIG. 3 is a flowchart illustrating signal detection according to an iterative MMSE method with maximum likelihood approximation and soft-decision updates (IMMSE-MLA-SD), according to an embodiment;

FIG. 4 is a flowchart illustrating signal detection according to an iterative MMSE method with maximum likelihood approximation using a limited number of candidate symbol vectors (IMMSE-MLn), according to an embodiment;

FIG. 5 is a block diagram of an electronic device in a network environment, according to an embodiment; and

FIG. 6 shows a system including a UE and a gNB in communication with each other.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

“MIMO communication system” as used herein refers to a wireless communication system employing multiple antennas at both the transmitter and receiver. Some examples of a “MIMO communication system” are cellular networks, Wi-Fi systems, and next-generation wireless standards such as 5G NR. “Signal vector” as used herein refers to a representation of received signals across multiple antennas or time instances in a MIMO communication system. Some examples of “signal vector” are the set of baseband samples received at different antennas of a wireless receiver. “Channel matrix” as used herein refers to a mathematical representation of the propagation characteristics between transmit antennas and receive antennas in a MIMO communication system. Some examples of “channel matrix” are a matrix of complex channel gains in a wireless link or a real-valued matrix representation used in iterative detection algorithms. “Symbol information” as used herein refers to data associated with possible transmitted symbols in a detection process, including initial assumptions, probabilities or estimates of symbol values. Some examples of “symbol information” are uniformly distributed prior probabilities for constellation points at initialization, updated likelihoods or posterior probabilities computed during iterative detection.

“Iterative MMSE detection process” as used herein refers to a signal detection method that repeatedly applies MMSE filtering while updating symbol information across iterations. Some examples of “iterative MMSE detection process” are successive refinements of soft symbol estimates using MMSE filtering, variance updates combined with posterior probability calculations, and feedback-based iterations that improve symbol detection accuracy in a MIMO communication system. “Real-value system model of the signal vector” as used herein refers to a representation of a complex-valued received signal vector in terms of equivalent real-valued components to facilitate detection processing. Some examples of “real-value system model of the signal vector” are separating the in-phase and quadrature components of complex baseband signals into real-valued vectors. “Symbol estimates” as used herein refers to provisional or final determinations of transmitted symbol values in a detection process. Some examples of “symbol estimates” are soft estimates expressed as probability distributions over a constellation, and hard-decision estimates corresponding to the most likely constellation point. “Soft symbol estimates” as used herein refers to probabilistic or weighted representations of possible transmitted symbols, rather than a single fixed decision. Some examples of “soft symbol estimates” are likelihood values assigned to each constellation point, and posterior probability distributions generated during iterative MMSE detection.

“Variances associated with soft symbol estimates” as used herein refers to measures of uncertainty or dispersion corresponding to the probabilistic symbol estimates in a detection process. Some examples of “variances associated with soft symbol estimates” are per-layer variance values computed from posterior distributions, variance terms used to weight linear MMSE filtering, and updated variance metrics. “Linear MMSE filter” as used herein refers to a filtering operation that linearly combines received signals using weighting coefficients chosen to minimize the mean square error between estimated and transmitted symbols. Some examples of “linear MMSE filter” are matrix-based filters, regularized inverse filters, and iterative filters. “Variance scaling” as used herein refers to adjusting calculated variance values to improve stability or accuracy in iterative detection processes. Some examples of “variance scaling” are multiplying variance terms by a scaling factor to control confidence levels of soft symbol estimates, applying normalization factors to prevent overestimation of reliability, and tuning variance values used in linear MMSE filtering within a MIMO communication system. “Posterior symbol information” as used herein refers to updated information about possible transmitted symbols after incorporating observed data and likelihood evaluations. Some examples of “posterior symbol information” are probability distributions over constellation symbols computed from likelihood functions, and refined symbol probabilities generated during iterative MMSE detection.

Embodiments of present disclosure may provide signal detection techniques for MIMO wireless communication systems. In particular, IMMSE detection methods may be provided that incorporate MLA procedures. These methods improve the accuracy of symbol detection in challenging channel conditions by combining iterative linear filtering with candidate expansion strategies. Depending on the embodiment, the method may operate using a real-valued system model, feed back hard-decision or soft-decision symbol estimates, or expand multiple symbol layers jointly to capture interdependencies across transmit streams. The disclosed methods may be carried out in whole or in part by processing elements of a wireless communication system that receive signal vectors and channel information.

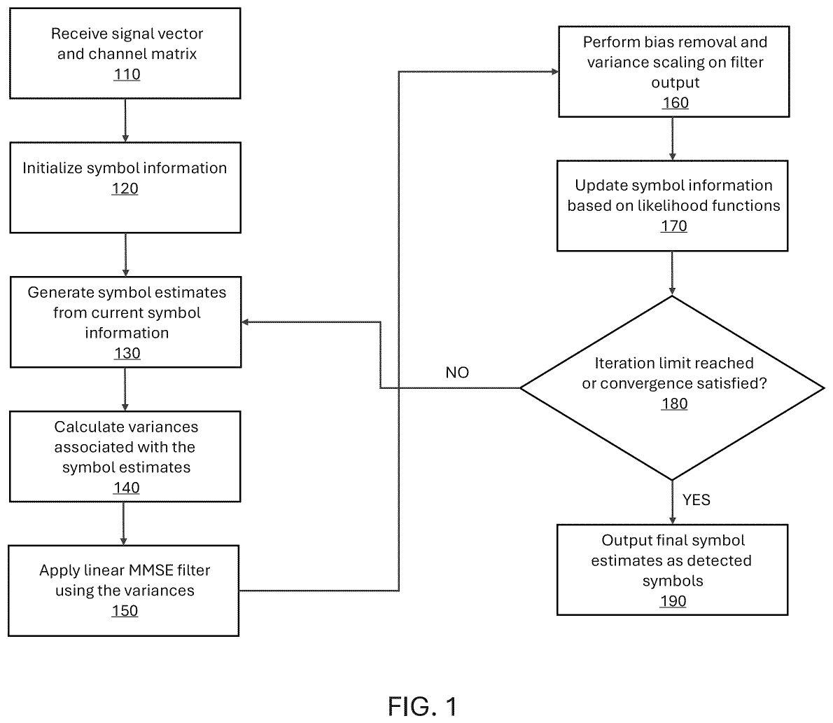

FIG. 1 is a flowchart illustrating signal detection according to an IMMSE-Real method, according to an embodiment.

The method of FIG. 1 can be applied in a MIMO communication system. As inputs, the method receives a signal vector y corresponding to signals received at a plurality of antennas, a channel matrix H characterizing the transmission channel between transmit antennas and receive antennas, a noise variance parameter σ², and a signal constellation set S representing possible transmitted symbols. In addition, a number of iterations T may be specified to control how many times the detection loop is performed, M may represent the number of receive antennas and N may represent the number of transmit antennas. Here, the channel matrix H is represented as H∈ [symbol] , and the received signal y is represented as y∈ [symbol] .

Referring to FIG. 1, at step 110, the receiver obtains a signal vector y and an associated channel matrix H. The signal vector y comprises baseband samples collected across the plurality of receive antennas over a common time-frequency resource (e.g., an OFDM symbol, subcarrier, or time slot). The channel matrix H characterizes the propagation between each transmit antenna and each receive antenna for that resource and may be estimated using pilot/sounding signals, decision-directed estimation, or retrieved from previously stored estimates with interpolation/extrapolation. In some embodiments, y and H are initially represented in the complex domain and, for processing according to the method, are mapped to an equivalent real-valued representation (e.g., stacking real and imaginary parts) sized to correspond to the number of receive and transmit antennas. Optionally, ancillary parameters such as noise variance σ² and the signal constellation S are also obtained at this step for use in subsequent processing.

At step 120, the process initializes symbol information for each symbol position corresponding to a transmit antenna stream. In one embodiment, initialization comprises assigning a uniform prior probability distribution over the modulation constellation set S, such that each symbol value is considered equally likely at the start of the detection process. For example, for a constellation set of size |S|, the initialization assigns

$${p}_{i}^{0} ( s \vert y ) = \frac{1}{\sqrt{\vert 𝒮 \vert}}$$

for each symbol s∈S and for each transmit stream index i. This initialization ensures that the method begins without bias toward any particular symbol hypothesis. In other embodiments, the initialization may incorporate a priori information, such as log-likelihood ratios (LLRs) derived from channel coding, reliability information from an outer decoder, or symbol statistics carried over from a previous time interval. The initialized symbol information provides the starting point for computing soft symbol estimates and associated variances in the subsequent iteration loop.

Next, the method enters an iterative loop in which symbol estimates are refined across successive iterations. The loop may be performed for a predetermined number of iterations T, or until a convergence criterion is satisfied, such as stability of posterior probabilities, reduction of residual error below a threshold, or reaching a maximum iteration count. Each iteration begins with the current symbol information (e.g., prior or posterior probabilities) and proceeds through a sequence of estimation, variance computation, filtering, and posterior update steps. The loop structure enables the detection method to progressively reduce detection error by using the received signal vector and updated symbol likelihoods across iterations.

At step 130, the method generates symbol estimates for each transmit stream based on the current symbol information. In one embodiment, the symbol estimates are computed as expectation values over the modulation constellation, using the posterior or prior probabilities available at the current iteration. For each symbol position i and iteration index t, the soft estimate

$${\hat{x}}_{i}^{t}$$

is given by equation 1:

$${\hat{x}}_{i}^{t} = {\sum }_{s ∈ S} s \times {p}_{i}^{t} ( s \vert y ) \qquad ( 1 )$$

where S is the constellation set and

$${p}_{i}^{t} ( s \vert y )$$

is the current probability associated with symbol s at position i.

This operation produces soft estimates of the transmitted symbols, rather than hard decisions, which allows uncertainty information to be preserved across iterations. The resulting estimates

$${\hat{x}}_{i}^{t}$$

serve as inputs to subsequent steps for variance calculation and MMSE filtering.

At step 140, the method calculates variances associated with the symbol estimates generated in step 130. The variances quantify the reliability of the estimates by measuring the expected squared deviation between each constellation symbol and the current soft estimate. For each symbol position i and iteration index t, the variance vf may be expressed by equation (2):

$${v}_{i}^{t} = {\sum }_{s ∈ ℛ ( 𝒮 )} {\vert s - {\hat{x}}_{i}^{t} \vert}^{2} \times {p}_{i}^{t} ( s \vert y ) \qquad ( 2 )$$

where

$${\hat{x}}_{i}^{t}$$

is the soft estimate computed is step 130, and

$${p}_{i}^{t} ( s \vert y )$$

is the probability assigned to symbol s.

These variances are propagated forward and used in the MMSE filtering stage to weight different symbol positions according to their relative reliability. Lower variance indicates higher confidence in the corresponding estimate, while higher variance reflects greater uncertainty.

At step 150, the method applies a linear MMSE filter to the received signal vector using the variances computed in step 140 and the channel matrix obtained in step 110. The filter is designed to suppress noise and interference by weighting symbol estimates according to their reliabilities.

In an embodiment, the filter matrix \tilde{W} is first computed as shown by equation (3)

$$\tilde{W} = {( {H}^{T} H + diag ( \frac{{σ}^{2}}{{v}^{t}} ) )}^{- 1} {H}^{T} \qquad ( 3 )$$

where H is the channel matrix, v^{t} is the vector of symbol variances from step 140, and σ² is the noise variance. To normalize the contributions of each symbol layer, a scaling matrix is applied to form the final MMSE filter W as shown by equation (4):

$$W = {diag ( \tilde{W} H )}^{- 1} \tilde{W} \qquad ( 4 )$$

The MMSE filter W is then used in subsequent steps to update the symbol estimates by combining the received signal vector with the reconstructed signal based on current estimates.

At step 160, the method updates the symbol estimates using soft cancellation and the MMSE filter from step 150, and applies bias-removal/variance-scaling to the filter output. In an embodiment, a residual-aided update is computed as shown by equation (5):

$${r}^{t} = {\hat{x}}^{t} + W ( y - H {\hat{x}}^{t} ) \qquad ( 5 )$$

where \hat{x}^{t} is the vector of soft symbol estimates from step 130, H is the channel matrix, y is the received vector, and W is the MMSE filter from step 150. This operation performs soft interference cancellation (y−H\hat{x}^{t}) followed by MMSE filtering and combines the result with the prior estimate.

To address residual linear bias, the filter may be normalized (e.g., via the diag (\tilde{W}H)⁻¹ scaling already used in forming W at step 150). Additionally, variance scaling may be applied to rt (e.g., using per-dimension scaling factors derived from the current reliability/variance information) to align the dispersion of the updated estimates with the modeled output variance. The resulting vector rt serves as the bias-corrected, variance-adjusted estimate that will be used to compute output variances and likelihoods in step 170.

At step 170, the method (i) computes output variances associated with the MMSE-filtered update from step 160 and (ii) updates the symbol information (posteriors) using likelihood functions evaluated at those variances.

In an embodiment, a linear transform shown by equation (6):

$$B = {I}_{2 N} - WH \qquad ( 6 )$$

is formed and the per-dimension output variance vector the is computed as shown by equation (7):

$${τ}^{t} = diag ( B diag ( {v}^{t} ) {B}^{T} ) + \frac{{σ}^{2}}{2} diag ( {WW}^{T} ) \qquad ( 7 )$$

where v^{t} is the variance vector from step 140 and σ² is the noise variance.

Given the updated estimate vector rt (step 160) and the per-dimension variance

$${τ}_{i}^{t} ,$$

a Gaussian likelihood may be evaluated for each constellation symbol s∈S and each position i as shown by equation (8):

$$p ( {r}_{i}^{t} \vert {x}_{i} = s ; {τ}_{i}^{t} ) = \frac{1}{2 β π {τ}_{i}^{t}} exp ( - \frac{{\vert {r}_{i}^{t} - s \vert}^{2}}{2 β {τ}_{i}^{t}} ) , for i = 1 : 2 Ns , and s ∈ ( 𝒮 ) \qquad ( 8 )$$

The posterior symbol information is then updated (normalized over s∈S) as shown by equation (9):

$${p}_{i}^{t + 1} ( s \vert y ) = p ( {x}_{i} = s \vert {r}_{i}^{t} ; {τ}_{i}^{t} ) = \frac{p ( {r}_{i}^{t} \vert {x}_{i} = s ; {τ}_{i}^{t} )}{{\sum }_{{s}^{′} ∈ s} p ( {r}_{i}^{t} \vert {x}_{i} = {s}^{′} ; {τ}_{i}^{t} )} , for i = 1 : 2 N , and \\ s ∈ ( 𝒮 ) \qquad ( 9 )$$

The updated distributions

$$\{ {p}_{i}^{t + 1} ( s \vert y ) \}$$

constitute the symbol information supplied to the next iteration (step 180 decision→loop back to step 130 if another iteration is to be performed), and ultimately provide the basis for final symbol estimates output at step 190.

At step 180, the method determines whether to continue the iterative loop or to terminate and produce final symbol estimates. In an embodiment, the loop is executed for a predetermined number of iterations T, such that the iteration counter is compared against T and the loop is exited once the counter reaches this limit. In another embodiment, the method evaluates a convergence condition, such as detecting that changes in the posterior probabilities

$${p}_{i}^{t} ( s \vert y )$$

between successive iterations fall below a threshold, that residual error power has decreased to within a tolerance of the noise variance, or that the symbol estimates

$${\hat{x}}_{i}^{t}$$

remain substantially unchanged. If the stopping condition is not satisfied, the method returns to step 130 to generate new symbol estimates using the updated symbol information. If the stopping condition is satisfied, the method proceeds to step 190 to output the final detected symbols.

At step 190, the method outputs the final symbol estimates derived from the iterative loop as the detected symbols for the received signal vector. In an embodiment, the output comprises hard-decision symbols, where the most likely constellation symbol is selected for each transmit stream based on the posterior information updated during step 170. In another embodiment, the output may include soft symbol estimates or associated reliability information, such as probability values or LLRs, which can be supplied to subsequent decoding stages. The detected symbols, whether in hard or soft form, represent the end result of the IMMSE-Real method, after which the method may terminate.

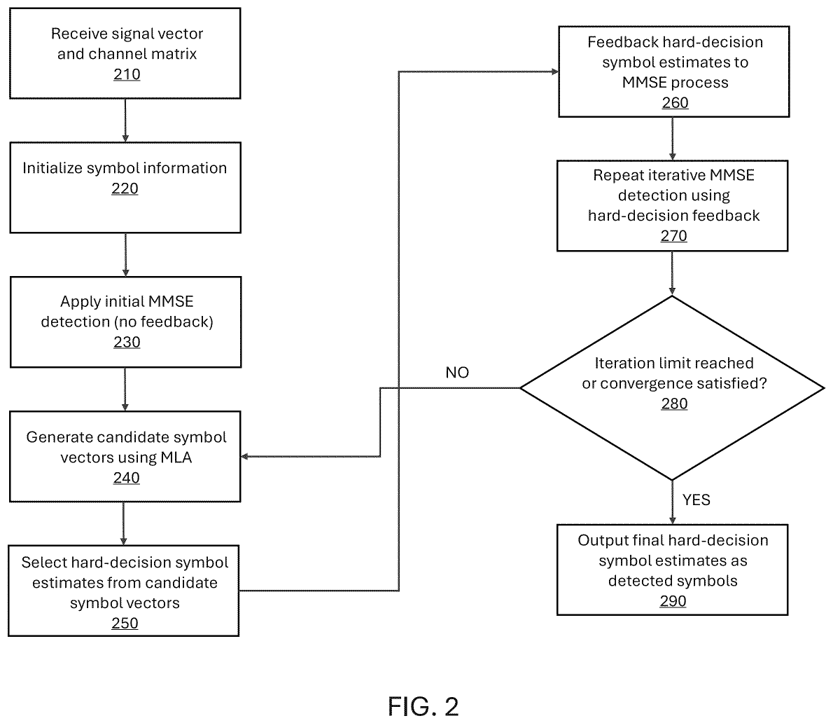

FIG. 2 is a flowchart illustrating signal detection according to an iterative MMSE method with IMMSE-MLA-HD, according to an embodiment.

Referring to FIG. 2, at step 210, the receiver obtains the real-valued channel matrix H∈ [symbol] and the real-valued received signal vector y∈ [symbol] , where M is the number of receive antennas and N is the number of transmit antennas. In addition, the method acquires additional parameters including the noise variance σ², the signal constellation S, a variance-scaling factor β, and a target iteration count T. These inputs are used in subsequent steps to generate candidate symbol vectors and to perform iterative MMSE detection.

At step 220, the method initializes the data structures used to accumulate likelihood information during MLA processing. In an embodiment, a probability accumulator P∈ [symbol] is initialized to zeros, where each entry P_{i,j} corresponds to the contribution of constellation symbol s; to the detection of transmit layer i. In addition, initial symbol information may be set to uniform probabilities across the constellation, such that each

$${p}_{i}^{0} ( s \vert y ) = 1 / \vert S \vert ,$$

thereby providing an unbiased starting point prior to candidate generation. This initialization ensures that the MLA loop in step 240 begins from a neutral distribution while also enabling accumulation of candidate-based likelihood values in P.

At step 230, the method performs what is referred to in the flowchart as an initial MMSE detection pass. This step corresponds to the preparation phase of the MLA procedure. Here, a transmit layer index iₘₗ is selected for candidate expansion, the corresponding channel column hₘₗ is extracted, and the reduced channel matrix Hᵢₘₘₛₑ is defined for the remaining layers. For each hypothesized constellation value xₘₗ=sⱼ∈ [symbol] , the received vector is updated as shown in equation (10):

$${y}_{immse} = y - {h}_{ml} {x}_{ml} \qquad ( 10 )$$

and the IMMSE method (FIG. 1) is invoked on (yᵢₘₘₛₑ, Hᵢₘₘₛₑ, σ², S, β, T). Thus, while labeled as “initial MMSE detection” in the flow diagram, this step represents the first application of the IMMSE method without any feedback from previously generated MLA hard decisions. The results provide the basis for generating candidate symbol vectors in step 240.

At step 240, the process generates candidate symbol vectors using an MLA procedure. In an embodiment, for each transmit layer index iₘₗ selected in step 230, the method iterates over the possible constellation values sⱼ∈ [symbol] for that layer. For each hypothesized symbol value, the received vector is updated as shown in equation (11):

$${y}_{immse} = y - {h}_{ml} {s}_{j} \qquad ( 11 )$$

where hₘₗ is the channel column associated with the selected layer. The reduced system (yᵢₘₘₛₑ, Hᵢₘₘₛₑ), together with the noise variance σ², constellation S, variance-scaling factor β, and iteration count T, is provided as input to the IMMSE method described in FIG. 1.

The IMMSE method produces posterior distributions for the remaining N−1 layers, from which provisional symbol estimates are derived. A complete candidate symbol vector \hat{x} is then constructed by assigning the fixed hypothesized value to layer imt and filling in the other entries with the IMMSE-derived estimates. The likelihood of this candidate vector is evaluated according to equation (12):

$$p ( \hat{x} \vert y ) ∝ exp ( - \frac{1}{{σ}^{2}} {‖ y - H \hat{x} ‖}^{2} ) \qquad ( 12 )$$

These likelihood values are accumulated into the probability matrix P, with entries P_{i,j} corresponding to the contribution of symbol sⱼ for layer i. This accumulation across multiple hypothesized candidates allows the MLA procedure to approximate the marginal posterior probabilities for each symbol layer.

At step 250, the method selects hard-decision symbol estimates from among the candidate symbol vectors generated in step 240. In an embodiment, the selection is based on the accumulated probability values stored in the matrix P. For each transmit layer index i, the entry corresponding to the maximum accumulated likelihood is identified, and the associated constellation symbol is chosen as the hard-decision estimate \hat{x}ᵢ. This may be implemented either by summing the candidate contributions in a log-MAP mode, or by retaining the maximum contribution in a max-log-MAP mode, depending on the desired tradeoff between accuracy and complexity.

The result of this step is a vector of hard-decision symbol estimates, one for each transmit layer, that represents the most likely symbol combination consistent with the evaluated MLA candidates. These estimates are then fed back to the iterative MMSE detection process in step 260, where they are used to refine detection in subsequent iterations.

At step 260, the hard-decision symbol estimates selected in step 250 are fed back into the iterative MMSE detection process. In an embodiment, the hard-decision vector \hat{x} is used to update the residual error signal and the variance information employed by the IMMSE method. This feedback distinguishes the IMMSE-MLA-HD method from the IMMSE-Real method of FIG. 1, in which only soft probabilities are propagated. Here, the loop reintroduces definitive symbol decisions as input to the next IMMSE evaluation, enabling the detection process to iteratively refine its estimates with progressively stronger constraints. The updated residuals and variances are then carried forward into step 270, where the IMMSE detection method is repeated under the influence of the feedback.

At step 270, the method repeats the iterative MMSE detection procedure using the hard-decision symbol estimates fed back from step 260. In this embodiment, the IMMSE method (FIG. 1) is re-invoked with the updated residual observation and reduced symbol uncertainty, where one or more layers are now treated as fixed to the hard-decision values. The detection proceeds through multiple iterations, recomputing symbol estimates, variances, and likelihoods under these new constraints.

In some embodiments, step 270 (repeating the iterative MMSE process) may be an optional operation that is internal to the IMMSE procedure or omitted entirely, depending on implementation. The feedback of symbol estimates described with respect to step 270 may instead be performed as part of the internal iterations of the IMMSE process itself.

By incorporating the hard-decision feedback, the iterative loop refines the remaining uncertain symbol layers and improves convergence. This step is performed repeatedly until either the target iteration count T is reached or the convergence condition defined in step 280 is satisfied. The results of this step provide updated symbol information that forms the basis for the termination check in step 280 and the final outputs in step 290.

At step 280, the method determines whether the MLA-HD loop should continue. The decision may be based on reaching a specified iteration count T or satisfying a convergence condition, such as stabilization of the hard-decision vector or reduction of the residual error below a threshold. If not satisfied, the process returns to step 240 for further candidate generation.

At step 290, once the stopping condition is met, the final hard-decision symbol estimates are output as the detected symbols for the received vector. These outputs may be provided directly to a decoder or other higher-layer processing stages. The method may then terminate.

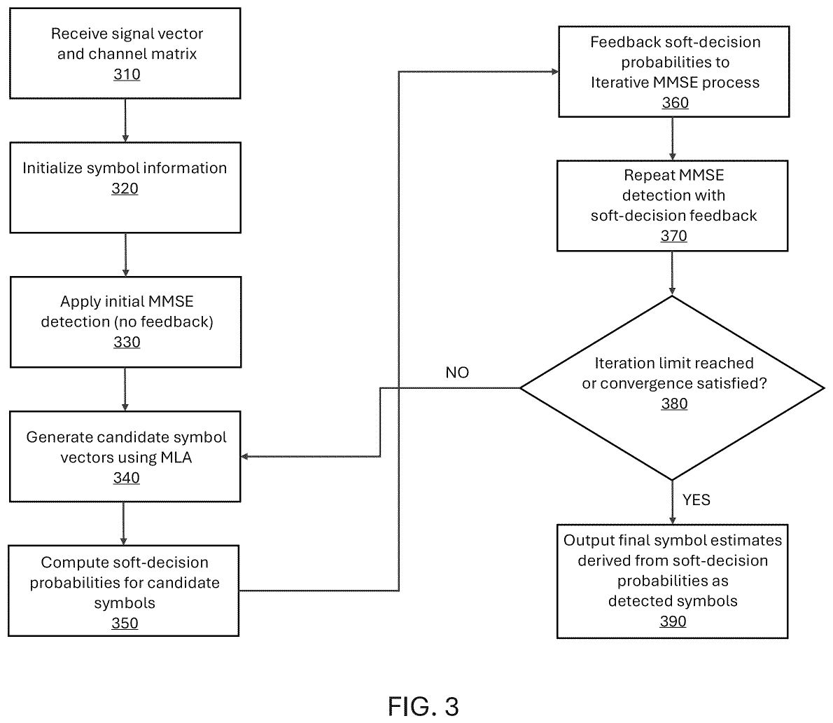

FIG. 3 is a flowchart illustrating signal detection according to an iterative MMSE method with maximum likelihood approximation and soft-decision updates (IMMSE-MLA-SD), according to an embodiment.

More specifically, FIG. 3 illustrates a variant of the IMMSE-MLA detection process in which soft-decision probabilities, rather than hard-decision symbols, are fed back into the iterative MMSE method. This approach preserves reliability information during the feedback loop and enables improved detection performance compared to the hard-decision method of FIG. 2.

Referring to FIG. 3, at steps 310 and 320, the system obtains the channel matrix, received vector, and related parameters, and initializes symbol information and accumulator structures. These steps may be performed as described in steps 210 and 220 of FIG. 2.

At step 330, the method applies an IMMSE method in the same manner as described in step 230 of FIG. 2, preparing reduced systems for MLA candidate generation.

At step 340, candidate symbol vectors are generated in accordance with the MLA process described in step 240 of FIG. 2.

At step 350, the method computes soft-decision probabilities for each transmit layer and constellation symbol, based on the accumulated likelihood values generated in step 340. In one embodiment, the accumulated entries in the probability matrix P are normalized across all constellation symbols to yield marginal posterior distributions of the form shown by equation (12).

This normalization corresponds to the final accumulation step of the MLA procedure described with respect to FIG. 2. However, rather than collapsing the normalized values to a hard-decision estimate (e.g., selecting the maximum as in step 250 of FIG. 2), the present embodiment retains the full set of normalized probabilities as soft-decision information. These probability values preserve reliability information and are used in step 360 as feedback to the IMMSE method.

At step 360, the soft-decision probabilities are fed back into the IMMSE method, replacing the hard-decision feedback of FIG. 2 step 260. This enables iterative refinement while preserving uncertainty information.

At step 370, the IMMSE detection is repeated using the fed-back probabilities, in a manner similar to step 270 of FIG. 2, but with probability-weighted updates instead of fixed symbol assignments. In some embodiments, step 370 (repeat MMSE detection) may be an optional operation that is internal to the IMMSE procedure or omitted entirely, depending on implementation. The feedback of soft-decision symbol estimates described with respect to step 370 may instead be performed as part of the internal iterations of the IMMSE detection process itself.

At steps 380 and 390, the method checks for iteration limits or convergence and, if satisfied, outputs final symbol estimates based on the soft-decision probabilities. These steps correspond to steps 280 and 290 of FIG. 2, but with outputs taken from probability distributions rather than hard-decision symbols.

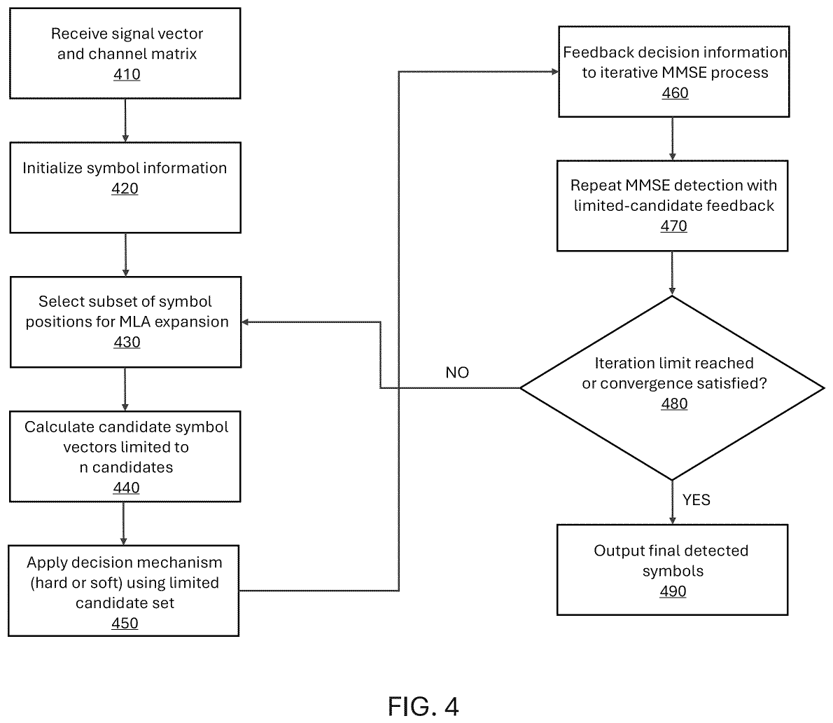

FIG. 4 is a flowchart illustrating signal detection according to an iterative MMSE algorithm with maximum likelihood approximation using a limited number of candidate symbol vectors (IMMSE-MLn), according to an embodiment.

More specifically, FIG. 4 illustrates a variant of the IMMSE-MLA detection method in which multiple symbol layers are jointly expanded into candidate vectors, rather than a single layer at a time as in FIGS. 2 and 3. This multi-layer expansion provide a more accurate likelihood evaluation of symbol combinations across transmit streams and improved detection performance in scenarios with strong inter-layer interference.

Referring to FIG. 4, at steps 410 and 420, the system obtains the channel matrix, received signal vector, and system parameters, and initializes the symbol information and accumulator structures. These steps may be performed as described in steps 210 and 220 of FIG. 2. In FIG. 4, the number of ML layers, nml, is denoted as n.

At step 430, the process selects two or more symbol layers to be jointly expanded in the MLA procedure. Unlike FIGS. 2 and 3, where only a single layer is expanded at a time, this embodiment considers a subset of layers simultaneously, allowing candidate vectors to be generated that capture interdependencies between multiple transmit streams. The subset may be chosen according to predefined scheduling, random selection, or based on reliability information from prior IMMSE iterations (e.g., layers with lower confidence may be prioritized for expansion).

At step 440, the method generates candidate symbol vectors by jointly expanding multiple transmit layers. For each selected subset of layers (see step 430), the method iterates over possible assignments of constellation symbols to those layers. Each assignment defines a partial symbol vector in which the subset entries are fixed, while the remaining layers are left to be detected.

At step 450, for each candidate assignment defined in step 440, the IMMSE method described in FIG. 1 is applied to the reduced system of the remaining unfixed layers. The IMMSE method outputs posterior distributions and provisional symbol estimates for these layers. A complete candidate vector x is then constructed by combining the fixed subset values from step 440 with the IMMSE-derived estimates for the unfixed layers.

At step 460, the process evaluates the likelihood of each complete candidate vector \hat{x} generated in step 450. In one embodiment, the likelihood is computed according to equation (14). This likelihood expression corresponds to the same measure used in the MLA procedure of FIG. 2, but in this embodiment it is applied to multi-layer candidate vectors constructed by fixing symbols across multiple transmit layers simultaneously. The resulting likelihood values are accumulated into the probability matrix P, updating the contributions associated with the symbols in the expanded subset. Unlike FIGS. 2 and 3, which update likelihoods on a per-layer basis, this embodiment accounts for joint symbol assignments across multiple layers, thereby capturing dependencies between transmit streams more directly.

At step 470, the accumulated results are used to update symbol information, either as hard-decision selections or as normalized soft probabilities, in a manner similar to FIGS. 2 and 3. These updated values are then fed back into the iterative IMMSE method for refinement. In some embodiments, step 470 (repeat MMSE detection) may be an optional operation that is internal to the IMMSE procedure or omitted entirely, depending on implementation. The feedback of soft-decision symbol estimates described with respect to step 470 may instead be performed as part of the internal iterations of the IMMSE detection process itself.

At steps 480 and 490, the method checks for convergence or an iteration limit, and outputs the final symbol estimates. These steps may be performed as described in steps 280 and 290 of FIG. 2. The method may then terminate.

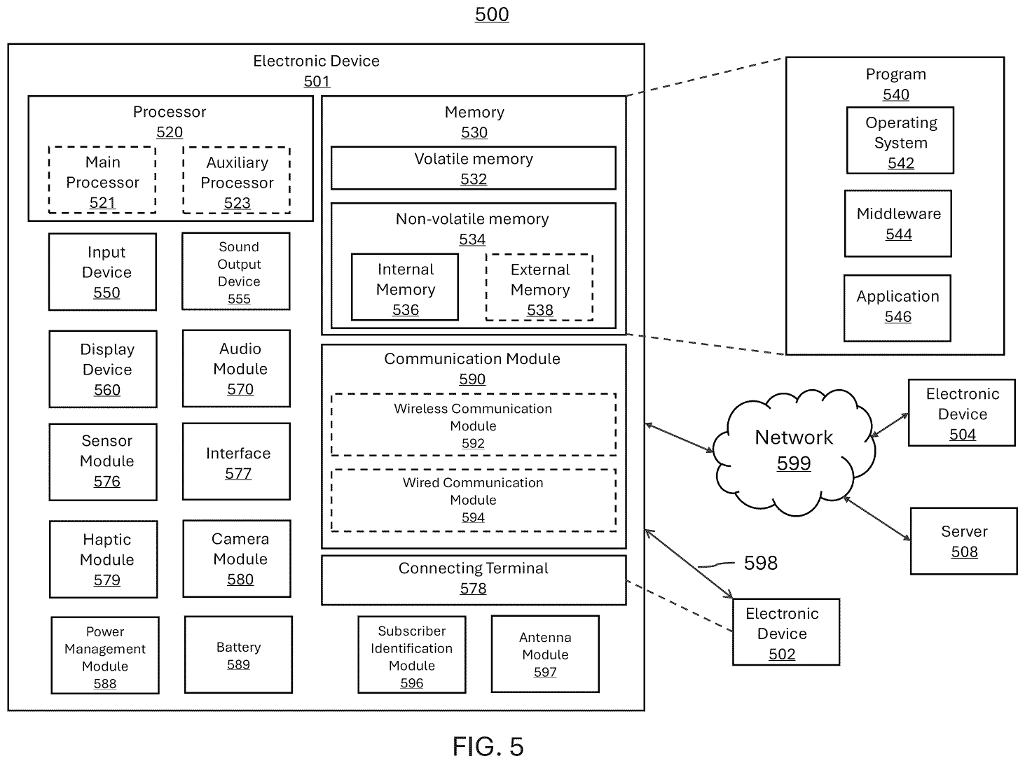

FIG. 5 is a block diagram of an electronic device in a network environment 500, according to an embodiment.

Referring to FIG. 5, an electronic device 501 in a network environment 500 may communicate with an electronic device 502 via a first network 598 (e.g., a short-range wireless communication network), or an electronic device 504 or a server 508 via a second network 599 (e.g., a long-range wireless communication network). The electronic device 501 may communicate with the electronic device 504 via the server 508. The electronic device 501 may include a processor 520, a memory 530, an input device 550, a sound output device 555, a display device 560, an audio module 570, a sensor module 576, an interface 577, a haptic module 579, a camera module 580, a power management module 588, a battery 589, a communication module 590, a subscriber identification module (SIM) card 596, or an antenna module 597. In one embodiment, at least one (e.g., the display device 560 or the camera module 580) of the components may be omitted from the electronic device 501, or one or more other components may be added to the electronic device 501. Some of the components may be implemented as a single integrated circuit (IC). For example, the sensor module 576 (e.g., a fingerprint sensor, an iris sensor, or an illuminance sensor) may be embedded in the display device 560 (e.g., a display).

The processor 520 may execute software (e.g., a program 540) to control at least one other component (e.g., a hardware or a software component) of the electronic device 501 coupled with the processor 520 and may perform various data processing or computations.

As at least part of the data processing or computations, the processor 520 may load a command or data received from another component (e.g., the sensor module 576 or the communication module 590) in volatile memory 532, process the command or the data stored in the volatile memory 532, and store resulting data in non-volatile memory 534. The processor 520 may include a main processor 521 (e.g., a central processing unit (CPU) or an application processor (AP)), and an auxiliary processor 523 (e.g., a graphics processing unit (GPU), an image signal processor (ISP), a sensor hub processor, or a communication processor (CP)) that is operable independently from, or in conjunction with, the main processor 521. Additionally or alternatively, the auxiliary processor 523 may be adapted to consume less power than the main processor 521, or execute a particular function. The auxiliary processor 523 may be implemented as being separate from, or a part of, the main processor 521.

The auxiliary processor 523 may control at least some of the functions or states related to at least one component (e.g., the display device 560, the sensor module 576, or the communication module 590) among the components of the electronic device 501, instead of the main processor 521 while the main processor 521 is in an inactive (e.g., sleep) state, or together with the main processor 521 while the main processor 521 is in an active state (e.g., executing an application). The auxiliary processor 523 (e.g., an image signal processor or a communication processor) may be implemented as part of another component (e.g., the camera module 580 or the communication module 590) functionally related to the auxiliary processor 523.

The memory 530 may store various data used by at least one component (e.g., the processor 520 or the sensor module 576) of the electronic device 501. The various data may include, for example, software (e.g., the program 540) and input data or output data for a command related thereto. The memory 530 may include the volatile memory 532 or the non-volatile memory 534. Non-volatile memory 534 may include internal memory 536 and/or external memory 538.

The program 540 may be stored in the memory 530 as software, and may include, for example, an operating system (OS) 542, middleware 544, or an application 546.

The input device 550 may receive a command or data to be used by another component (e.g., the processor 520) of the electronic device 501, from the outside (e.g., a user) of the electronic device 501. The input device 550 may include, for example, a microphone, a mouse, or a keyboard.

The sound output device 555 may output sound signals to the outside of the electronic device 501. The sound output device 555 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 560 may visually provide information to the outside (e.g., a user) of the electronic device 501. The display device 560 may include, for example, a display, a hologram device, or a projector and control circuitry to control a corresponding one of the display, hologram device, and projector. The display device 560 may include touch circuitry adapted to detect a touch, or sensor circuitry (e.g., a pressure sensor) adapted to measure the intensity of force incurred by the touch.

The audio module 570 may convert a sound into an electrical signal and vice versa. The audio module 570 may obtain the sound via the input device 550 or output the sound via the sound output device 555 or a headphone of an external electronic device 502 directly (e.g., wired) or wirelessly coupled with the electronic device 501.

The sensor module 576 may detect an operational state (e.g., power or temperature) of the electronic device 501 or an environmental state (e.g., a state of a user) external to the electronic device 501, and then generate an electrical signal or data value corresponding to the detected state. The sensor module 576 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 577 may support one or more specified protocols to be used for the electronic device 501 to be coupled with the external electronic device 502 directly (e.g., wired) or wirelessly. The interface 577 may include, for example, a high-definition multimedia interface (HDMI), a universal serial bus (USB) interface, a secure digital (SD) card interface, or an audio interface.

A connecting terminal 578 may include a connector via which the electronic device 501 may be physically connected with the external electronic device 502. The connecting terminal 578 may include, for example, an HDMI connector, a USB connector, an SD card connector, or an audio connector (e.g., a headphone connector).

The haptic module 579 may convert an electrical signal into a mechanical stimulus (e.g., a vibration or a movement) or an electrical stimulus which may be recognized by a user via tactile sensation or kinesthetic sensation. The haptic module 579 may include, for example, a motor, a piezoelectric element, or an electrical stimulator.

The camera module 580 may capture a still image or moving images. The camera module 580 may include one or more lenses, image sensors, image signal processors, or flashes. The power management module 588 may manage power supplied to the electronic device 501. The power management module 588 may be implemented as at least part of, for example, a power management integrated circuit (PMIC).

The battery 589 may supply power to at least one component of the electronic device 501. The battery 589 may include, for example, a primary cell which is not rechargeable, a secondary cell which is rechargeable, or a fuel cell.

The communication module 590 may support establishing a direct (e.g., wired) communication channel or a wireless communication channel between the electronic device 501 and the external electronic device (e.g., the electronic device 502, the electronic device 504, or the server 508) and performing communication via the established communication channel. The communication module 590 may include one or more communication processors that are operable independently from the processor 520 (e.g., the AP) and supports a direct (e.g., wired) communication or a wireless communication. The communication module 590 may include a wireless communication module 592 (e.g., a cellular communication module, a short-range wireless communication module, or a global navigation satellite system (GNSS) communication module) or a wired communication module 594 (e.g., a local area network (LAN) communication module or a power line communication (PLC) module). A corresponding one of these communication modules may communicate with the external electronic device via the first network 598 (e.g., a short-range communication network, such as BLUETOOTH™, wireless-fidelity (Wi-Fi) direct, or a standard of the Infrared Data Association (IrDA)) or the second network 599 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 592 may identify and authenticate the electronic device 501 in a communication network, such as the first network 598 or the second network 599, using subscriber information (e.g., international mobile subscriber identity (IMSI)) stored in the subscriber identification module 596.

The antenna module 597 may transmit or receive a signal or power to or from the outside (e.g., the external electronic device) of the electronic device 501. The antenna module 597 may include one or more antennas, and, therefrom, at least one antenna appropriate for a communication scheme used in the communication network, such as the first network 598 or the second network 599, may be selected, for example, by the communication module 590 (e.g., the wireless communication module 592). The signal or the power may then be transmitted or received between the communication module 590 and the external electronic device via the selected at least one antenna.

Commands or data may be transmitted or received between the electronic device 501 and the external electronic device 504 via the server 508 coupled with the second network 599. Each of the electronic devices 502 and 504 may be a device of a same type as, or a different type, from the electronic device 501. All or some of operations to be executed at the electronic device 501 may be executed at one or more of the external electronic devices 502, 504, or 508. For example, if the electronic device 501 should perform a function or a service automatically, or in response to a request from a user or another device, the electronic device 501, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 501. The electronic device 501 may provide the outcome, with or without further processing of the outcome, as at least part of a reply to the request. To that end, a cloud computing, distributed computing, or client-server computing technology may be used, for example.

The embodiments described herein may be performed by the processor 520 of the electronic device 501 shown in FIG. 5, including the main processor 521 (e.g., CPU or AP) and/or the auxiliary processor 523 (e.g., GPU, ISP, or communication processor), which are configured to execute the IMMSE-based detection methods described with respect to FIGS. 1-4. The memory 530 may store program instructions and intermediate data used in the detection process, while the communication module 590 and antenna module 597 provide the received signal vectors and channel information needed for the methods. Thus, the hardware supporting the methods is located within the processor and memory components of the electronic device 501, optionally operating together with the communication and sensor modules.

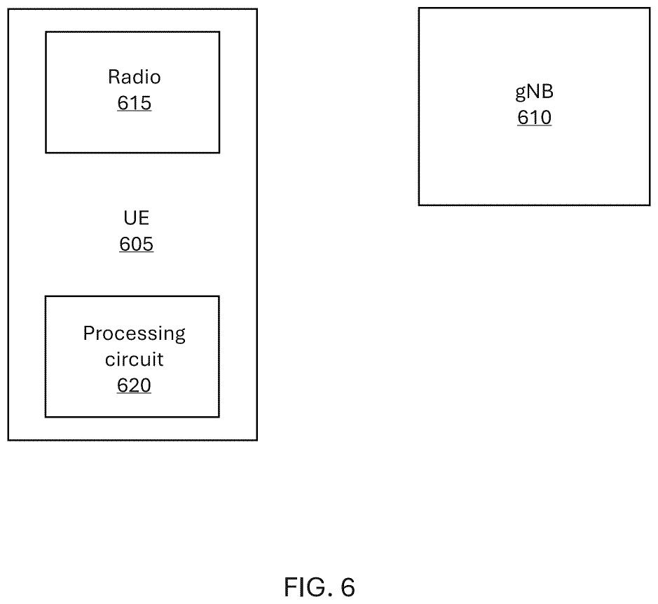

FIG. 6 shows a system including a UE 605 and a gNB 610, in communication with each other. The UE may include a radio 615 and a processing circuit (or a means for processing) 620, which may perform various methods disclosed herein, e.g., the method illustrated in FIG. 1. For example, the processing circuit 620 may receive, via the radio 615, transmissions from the network node (gNB) 610, and the processing circuit 620 may transmit, via the radio 615, signals to the gNB 610.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method of detecting signals in a multiple-input multiple-output (MIMO) communication system, the method comprising:
receiving a signal vector and a channel matrix associated with transmissions from a plurality of antennas;
initializing symbol information for the signal vector;
applying a minimum mean square error (MMSE) detection process to the signal vector to generate updated symbol information;
repeating the MMSE detection process for a plurality of iterations, each iteration including further updating the symbol information based on outputs of a previous iteration, wherein the MMSE detection process is performed using a real-valued system model of the signal vector; and
outputting final symbol information from the MMSE detection process as detected symbols.

2. The method of claim 1, wherein generating the updated symbol information comprises computing soft symbol estimates from the symbol information.

3. The method of claim 2, wherein generating the updated symbol information comprises applying a non-linear posterior-mean MMSE estimation to MMSE filtered outputs generated during the MMSE detection process to obtain posterior-mean symbol estimates and corresponding variances.

4. The method of claim 2, wherein the MMSE detection process further comprises calculating variances associated with the soft symbol estimates.

5. The method of claim 4, wherein applying the MMSE detection process includes applying a linear MMSE filter to the signal vector using the variances.

6. The method of claim 5, further comprising performing variance scaling on an output of the linear MMSE filter.

7. The method of claim 1, wherein the MMSE detection process includes updating posterior symbol information based on likelihood functions.

8. The method of claim 7, wherein the likelihood functions are Gaussian likelihood functions.

9. A method of detecting signals in a multiple-input multiple-output (MIMO) communication system, the method comprising:
receiving a signal vector and a channel matrix associated with transmissions from a plurality of antennas, each element of the signal vector corresponding to a receive antenna;
initializing symbol information for the signal vector;
applying a minimum mean square error (MMSE) detection process to the signal vector;
generating one or more candidate symbol vectors for one or more transmit layers using a maximum likelihood approximation (MLA), wherein each candidate symbol vector is expanded using the MMSE detection process applied to remaining transmit layers;
selecting hard-decision symbol estimates from among the evaluated candidate symbol vectors; and
outputting final hard-decision symbol estimates from the MMSE detection process as detected symbols.

10. The method of claim 9, wherein generating the one or more candidate symbol vectors comprises expanding symbols for two or more transmit layers into candidate symbol vectors.

11. The method of claim 9, wherein the hard-decision symbol estimates are fed back into the MMSE detection process to recompute variance values associated with the remaining transmit layers for use in subsequent MMSE MMSE filtering.

12. The method of claim 9, wherein generating the candidate symbol vectors using the MLA comprises limiting the candidate symbol vectors to a predetermined number of candidate symbol vectors.

13. A method of detecting signals in a multiple-input multiple-output (MIMO) communication system, the method comprising:
receiving a signal vector and a channel matrix associated with transmissions from a plurality of antennas, each element of the signal vector corresponding to a receive antenna;
initializing symbol information for the signal vector;
applying a minimum mean square error (MMSE) detection process to the signal vector;
generating one or more candidate symbol vectors for one or more transmit layers using a maximum likelihood approximation (MLA), wherein each candidate symbol vector is expanded using the MMSE detection process applied to remaining transmit layers;
computing soft-decision probabilities for symbols of the signal vector based on the evaluated candidate symbol vectors; and
outputting final symbol estimates from the soft-decision probabilities as detected symbols.

14. The method of claim 13, wherein computing the soft-decision probabilities comprises assigning likelihood values to candidate symbols of a constellation.

15. The method of claim 14, wherein the likelihood values are Gaussian likelihood values.

16. The method of claim 15, wherein generating the candidate symbol vectors using the maximum likelihood approximation comprises limiting the candidate symbol vectors to a predetermined number of candidates.
